(19) United States
(12) Patent Application Publication
(10) Pub. No.: US 2026/0257515 A1
(43) Pub. Date: Sep. 3, 2026

(54) ELECTROMECHANICAL SYSTEM FOR THE WHEEL HUB OF A VEHICLE

(71) Applicant: LUPA-Electronics GmbH, Lübs (DE)

(72) Inventors: Norman Weyrich, Wildenberg (DE); Jörn Ihlenburg, Berlin (DE); Benjamin May, Lübs (DE); Martin Stöckler, Dortmund (DE)

(73) Assignee: LUPA-Electronics GmbH, Lübs (DE)

(21) Appl. No.: 19/548,244

(22) Filed: Feb. 24, 2026

(30) Foreign Application Priority Data
Feb. 28, 2025 (DE) 102025107775.4

(51) Int. Cl. B60B 7/20; B60B 27/04; B60B 7/00

(52) U.S. Cl. CPC B60B 7/20; B60B 27/04; B60B 7/006

(57) ABSTRACT

An electromechanical system is to be fixedly arranged in a central cavity of a wheel hub of a vehicle including a generator for generating electric current, an electric motor for actuating an actuator, the actuator, and a storage system for storing electrical energy. The actuator is linearly movable along a longitudinal axis of the electromechanical system. A coupling device couples the motor to a radially inner part of the actuator. The storage system includes a plurality of storage elements which are radially arranged around the outside of the longitudinal axis and the motor and at least some of which are spaced apart from one another in a circumferential direction. A radially outer part of the actuator is formed radially beyond the storage elements, wherein connecting elements of the actuator rigidly connect the radially inner part and the radially outer part to one another and reach through between the storage elements.

### CROSS-REFERENCE TO RELATED APPLICATIONS

This application claims priority to German Patent Application DE 10 2025 107 775.4, filed February 28, 2025, the entire contents of which are hereby incorporated in full by this reference.

### DESCRIPTION: FIELD OF THE INVENTION

The invention relates to an electromechanical system, to be fixedly arranged in a central cavity of a wheel hub of a vehicle, wherein the electromechanical system comprises a generator for generating electric current, an electric motor for operating an actuator, the actuator, and a storage system for storing electrical energy.

### BACKGROUND OF THE INVENTION

Such an electromechanical system is disclosed by EP 3 530 482 A1.

Many types of vehicles have wheels that allow them to roll over the ground and thus travel over it. For numerous applications, it is advantageous or desirable to provide on the wheels that rotate relative to the vehicle functions which require electrical energy, such as monitoring functions. For example, it is often desirable to obtain information about the current rotational speed of the wheel, which can be done using electrical sensors arranged on the wheel.

However, the transmission of electric current from the vehicle to the rotating wheels is difficult, especially at high rotational speeds of the wheel. While sliding contacts are possible, they wear out easily, and accommodation of the sliding contacts and associated lines on the vehicle is very complex. Especially for sensors on wheels, it has therefore become known to supply these with electrical energy via a battery, which is attached to the wheel together with the sensor. The battery is replaced when it is dead, typically as part of maintenance work in a workshop. Batteries for supplying electrical energy to a rotating vehicle wheel and replacement of the batteries when dead are particularly appropriate if the energy consumption of the application is rather low and therefore replacement is hardly ever necessary (e.g., every few years).

In some applications, it is desirable to move elements on the rotating wheel during travel. This typically involves the use of an electric motor and an actuator driven by the motor.

For example, it has become known to provide a rim cover over the rim of a vehicle wheel. With the rim cover closed, particularly low vehicle wheel drag is achieved. However, the closed rim cover also covers openings in the rim through which cooling air can reach the vehicle's brakes on the vehicle wheel hub. If the brake were to get too hot (for example, when going downhill), the rim cover can be opened using a motor-driven actuator to allow more cooling air to reach the brake.

EP 3 530 482 A1 discloses the provision of a vehicle wheel with an electromechanical system, which is installed in the hub of the vehicle wheel. Said system comprises a rechargeable battery, a generator with an eccentric weight part and a circuit board. Electrical consumers to be supplied with power include a motor for actuating covers that can close spaces between radial ribs of an alloy wheel, or sensors for measuring rotational speed or temperature. The battery is designed as a button cell and is located at the front end of the electromechanical system, projecting into the hub.

This known electromechanical system can be used to establish a self-contained, vehicle-independent energy supply and can also be used to actuate the rim cover of a vehicle wheel by means of a motor. However, no further details are given about the arrangement of the motor.

An electromechanical system in the central cavity of a wheel hub must accommodate a significant number of components in a small space, while ensuring a high level of operational readiness.

The electromechanical system is arranged in the central cavity of the wheel hub, close to the vehicle's brakes. Failure of the electromechanical system can be caused, in particular, by the vehicle's brakes becoming hot after prolonged braking maneuvers, and this heat penetrating to the electromechanical system.

### SUMMARY OF THE INVENTION

### Object of the invention

The object of the invention is to present an electromechanical system of the type mentioned at the outset, with which a high level of operational readiness can be achieved in a compact space.

### Description of the invention

This object is achieved according to the invention by an electromechanical system of the type mentioned at the outset, which is characterized in that the actuator can be moved linearly along a longitudinal axis of the electromechanical system, in that a coupling device couples the motor to a radially inner part of the actuator, in that the storage system has a plurality of storage elements which are radially arranged around the outside of the longitudinal axis and around the motor and at least some of which are spaced apart from one another in a circumferential direction, and in that a radially outer part of the actuator is formed radially beyond the storage elements, wherein connecting elements of the actuator rigidly connect the radially inner part and the radially outer part to one another and reach through between the storage elements.

The invention provides for arranging the motor of the electromechanical system in a radially inner (with respect to the longitudinal axis of the electromechanical system) region near the axis. The storage elements of the rechargeable electrical energy storage system are arranged around the motor; the individual storage elements can be, for example, rechargeable batteries or capacitors.

With this arrangement, heat coming from the radial outside (which typically originates from a wall of the wheel hub radially surrounding the electromechanical system) initially acts on the storage elements located further outward in the radial direction. The storage elements can shield against heat radiation coming from the radial outside and also absorb and store thermal energy coming from the radial outside so that this thermal energy is kept away from the motor.

According to the inventors' observations, typical storage elements such as batteries or capacitors can withstand higher temperatures much better than an electric motor can. In particular, the storage elements can remain operational even at higher temperatures, unlike a motor which no longer functions reliably at higher temperatures or may even have to be switched off to avoid damage. In the case of chemically acting storage elements (such as batteries), an increased temperature can even slightly improve performance.

The arrangement of the storage elements according to the invention on the radial outside beyond the motor and around the motor thus allows high (long) operational readiness to be maintained when the electromechanical system is heated from radially outside.

In order to still be able to use the actuator on the radial outside of the electromechanical system despite the storage elements being arranged around the motor, the actuator is constructed with a radially inner part and a radially outer part. The radially inner part allows easy mechanical coupling to the radially inner motor. By means of the connecting elements according to the invention, which extend outward to the radially outer part of the actuator, the movement of the inner part can be transferred to the outer part of the actuator. The connecting elements extend through (azimuthal) gaps between the storage elements. The gaps extend far enough in the axial direction to allow the connecting elements enough space in every desired travel position of the actuator. Typically, the storage elements are aligned parallel to the longitudinal axis for this purpose.

Typically, the actuator is used to actuate a (one-piece or multi-piece) rim cover of the wheel. The rim cover is mechanically coupled to the outer part of the actuator for this purpose; this can be, for example, a rigid coupling (typically for a one-piece rim cover) or a pivot coupling (typically for a multi-piece rim cover). The coupling between the outer part of the actuator and the rim cover can be effected, in particular, via radially outwardly projecting tabs on the outer part of the actuator.

The electromechanical system also typically has one or more sensors that can be used to monitor the current state of the vehicle wheel. The sensor data are typically transmitted wirelessly to an electronic system of the vehicle, possibly after being preprocessed in an evaluation device in the electromechanical system. The sensors are typically arranged on a motherboard of the electromechanical system.

The longitudinal axis corresponds to a rotational axis of the wheel hub in the installed state of the electromechanical system.

When installed, the front end of the electromechanical system is inserted into the central cavity of the wheel hub; the rear end of the electromechanical system typically projects slightly from the cavity. The electromechanical system is fixed in place in the wheel hub (i.e., it rotates with the wheel hub). For this purpose, the electromechanical system is preferably fastened to the wheel hub of the vehicle and/or to the vehicle wheel in a suitable manner. Typically, the electromechanical system is attached directly to the wheel hub, for example by screwing a housing of the electromechanical system to the wheel hub. The electromechanical system can also be referred to as an electromechanical hub cap.

The electromechanical system can be used with normal wheels without any costly modification of the wheels. Preferably, the electromechanical system is fastened to the vehicle-mounted wheel hub for this purpose. The electromechanical system is energy self-sufficient via the generator and the storage system. Depending on the operating state, the generator supplies electrical energy not only directly to the consumers of the electromechanical system (e.g., the motor of the actuator and circuits for controlling the system) but also to the storage system (for later use by the consumers). The electromechanical system does not require a cable connection to the vehicle, neither for supplying energy nor for exchanging data; for data exchange, wireless communication can be powered by the energy from the generator and the storage system. Depending on the operating state, the generator charges the storage system and/or supplies the consumers of the electromechanical system with power, in particular, the motor, electronic circuits and evaluation devices, sensors and communication devices. If the generator needs to be switched off during operation, e.g., because the temperature of the generator is getting too high, the other consumers or a chosen number thereof can continue to be supplied with electrical energy from the storage system.

In summary, the electromechanical system can be designed to be overall resistant to environmental influences, especially heat radiation from the brakes. The system can be provided within a compact space and can be resistant to vibrations and external shocks. The system can be fastened to the wheel hub of the vehicle so that no modifications need to be made for installation on vehicle wheels. By the arrangement on the wheel hub or on the rotational axis of the wheel hub, centrifugal forces on the electromechanical system are minimized. The individual mechanical and electrical components of the electromechanical system (with the exception of an imbalance component of the generator) are preferably arranged symmetrically to the rotational axis of the wheel, which minimizes the imbalance of the electromechanical system (and of the vehicle as a whole).

A vehicle on which the invention can be used is, for example, a car (in particular a passenger car), a transport vehicle (in particular a truck), a construction vehicle (in particular an excavator or wheel loader), a military vehicle or a rail vehicle.

### Preferred embodiments of the invention

In a preferred embodiment of the electromechanical system according to the invention, it is provided that the coupling device comprises a spindle which is mounted so as to rotate about the longitudinal axis and which can be driven by the motor, that the spindle has an external thread that the actuator has on its radially inner part an internal thread, which is screwed onto the external thread of the spindle, and that the actuator is mounted such that it cannot rotate with respect to the longitudinal axis. The spindle makes it easy to convert a rotary movement of a shaft of the motor (or a shaft of an intermediate transmission) into a linear traveling movement of the actuator. The spindle can, in particular, be cup-shaped and radially surround a transmission and/or the motor.

A development of this embodiment is preferred in which the coupling device comprises a transmission which reduces the rotational movement of a shaft of the motor and transfers it to the spindle. This allows a more precise positioning of the actuator (or a rim cover), and the motor requires less force to actuate the actuator. The spindle can be cup-shaped and arranged radially around the transmission.

An embodiment is preferred in which a rim cover for a vehicle wheel mounted on the wheel hub is coupled to the radially outer part of the actuator. This allows the rim cover to be switched between a closed state (with low air drag of the wheel) and an open state (with better ventilation and thus better cooling of the vehicle wheel, the wheel hub, the vehicle wheel brakes and/or the electromechanical system). Intermediate positions (with moderate cooling and moderate air drag, depending on the position) are also possible within the scope of the embodiment. The actuation of the rim cover by means of the electromechanical system according to the invention is particularly reliable.

One advantageous embodiment provides that the electromechanical system has a front end, wherein the electromechanical system can be inserted into the cavity of the wheel hub with the front end ahead, and a rear end that is opposite said front end along the longitudinal axis, and that along the longitudinal axis from the front end to the rear end a sequence of components of the electromechanical system is arranged as follows:

generator, coupling device, motor. The front end is typically heated by the brakes of the vehicle wheel to a greater extent than is the rear end. Accordingly, the motor is protected from heat input from the front end by the generator and the coupling device. If the generator has to be deactivated due to the front end being heated, this does not initially affect the operational readiness of the motor and actuator since electrical energy continues to be available from the storage system. When the vehicle is stationary, the generator is automatically deactivated; this is advantageous because the highest temperatures typically occur immediately after heavy use of the brakes when the vehicle is stationary. The transmission, which is heated next after the generator, is relatively insensitive to heat. Of the components listed, it is the motor, which should have a high level of operational readiness for actuating the rim flaps, that is located furthest away from the front end and therefore in the coolest region.

Also advantageous is a development of this embodiment which provides that the electromechanical system also has an intermediate board and a motherboard, and that the sequence of components of the electromechanical system along the longitudinal axis from the front end to the rear end is arranged as follows: generator, intermediate board, coupling device, motor, motherboard. The intermediate board, which primarily serves for electrical connection, is relatively insensitive to heat and can therefore be positioned near the front end. The motherboard, on which several electronic elements sensitive to high temperatures (e.g., processors, sensors) are placed, is arranged near the rear end, which remains the coldest. The storage elements are located axially in the region of the motor and usually also in the region of the coupling device; the motherboard is therefore typically at least partially axially shielded by the storage elements. This ensures high (long) operational readiness, even when the system heats up from the front end. A motherboard arranged near the rear end also improves the transmission performance of a first communication unit and/or a second communication unit (see below) on the motherboard.

In an advantageous embodiment, the generator and the motor are of identical design. This saves costs in the production of the electromechanical system (economy of scale) and reduces the number of different elements required, which simplifies logistics.

Particularly preferred is an embodiment in which the electromechanical system comprises a sensor system, wherein the sensor system is configured for measuring linear movements of the electromechanical system with respect to at least a first local axis of movement and a second local axis of movement, which are linearly independent, as well as angular movements of the electromechanical system with respect to at least a first local axis of rotation and a second local axis of rotation that are linearly independent of one another.

The sensor system allows the measurement of the position, orientation, and movement of the associated vehicle wheel in space during driving. In this way, a large amount of information can be obtained (possibly also together with other electromechanical systems on other vehicle wheels of the vehicle) that is of interest for the operation of the vehicle. This information can be used, for example, to adjust vehicle characteristics and/or to control the vehicle, such as in an electronic stability program (ESP), an anti-lock braking system, or an adaptive suspension control system.

In particular, a vertical wheel movement can be determined. It is possible to draw conclusions about the road structure (asphalt, concrete, gravel, unpaved, …), the road condition (slippery, wet, …) and/or tire grip. In addition, the speed of rotation of the wheel can be determined ("horizontal wheel movement"). In addition, the sensor system can detect vibrations of the wheel. Alternatively or additionally, a separate vibration sensor device can, however, also be provided for vibration determination. In addition, further sensors may be provided on the electromechanical system, typically on the motherboard.

The sensor system measures at least two linear movements and two rotational movements, and accordingly generates 4D movement information.

The sensor system moves together with the electromechanical system, i.e., together with the wheel to the hub of which the electromechanical system is fastened. The sensor system is typically located on a motherboard of the electromechanical system.

All local movement axes with respect to which the linear movements are measured preferably form an orthogonal system. All local axes of rotation with respect to which the angular movements are measured preferably form an orthogonal system. If available, all local magnetic field measurement axes preferably also form an orthogonal system (see below).

Typically, the measured local axes of movement chosen are the same as the measured local axes of rotation, and may also be the same as the measured local magnetic field measurement axes.

The local axes of the electromechanical system (these are local axes of movement, local axes of rotation, local magnetic field measurement axes) move with the electromechanical system.

By means of a suitable coordinate transformation, the measurement data for the local axes of the electromechanical system can be converted to axles of the vehicle to whose wheel hub the electromechanical system is fastened. The coordinate transformation can take place in an evaluation unit of the electromechanical system, or alternatively in an electronic system of the vehicle. The vehicle's coordinate axes are fixed within the vehicle and therefore move together with the entire vehicle.

Typically, the coordinate axes of the vehicle, to which the measured data are converted, are chosen as follows: x-axis, which is the (horizontal) forward direction of travel of the vehicle; y-axis, which is the horizontal direction perpendicular to the forward direction of travel; and z-axis, which is the vertical direction perpendicular to the forward direction of travel.

The x-axis as an axis of rotation corresponds to the roll axis, the y-axis as an axis of rotation corresponds to the pitch axis, and the z-axis as an axis of rotation corresponds to the yaw axis.

Linear (straight-line) movements are typically measured by means of accelerometers. An embodiment is also preferred which provides that the electromechanical system has a housing which has a longitudinal wall extending at least substantially along the longitudinal axis and in which at least one passage point for the actuator is provided, that, in the region of each passage point in the longitudinal wall, an outer wall part and an inner wall part are provided, which extend in parallel with the longitudinal axis, but are spaced apart from one another in the transverse direction perpendicular to the longitudinal axis, are at least partially offset from one another along the longitudinal axis so that an inner free end of the inner wall part and an outer free end of the outer wall part lie opposite one another in the region of the passage point, and that, at each passage point, the actuator has: a central portion that extends along the longitudinal axis and is arranged between the inner wall part and the outer wall part in the transverse direction, an inner collar that is formed at one end of the central portion, remote from the inner free end, and extends inward in the transverse direction beyond the inner free end, and an outer collar that is formed at one end of the central portion, remote from the outer free end, and extends outward in the transverse direction beyond the outer free end. With this embodiment, the actuator can easily extend outward through the housing, thus causing movement (e.g., of a rim cover) outside the housing, while at the same time largely covering the passage point and thus protecting the inside of the housing from contamination. As the actuator moves, its central portion moves in front of the inner wall part and behind the outer wall part in the radial space between these wall parts. The inner and outer collars allow the definition of an end position for the actuator and minimize dirt ingress via the free end of each wall part. The axial length of the central portion between the collars determines (insofar as this relates to the passage point) the maximum travel distance of the actuator. An element to be actuated, e.g., a rim cover or part thereof, can be coupled to the outer part of the actuator.

The angular movements are typically measured by means of a gyroscope.

Magnetic field strengths are typically measured by means of Hall effect or magnetoresistive (MR) sensors.

A development of this embodiment is preferred in which the sensor system is also configured to measure linear movements of the electromechanical system with respect to a third local axis of movement, wherein all the local axes of movement are linearly independent, and also angular movements of the electromechanical system with respect to a third local axis of rotation, wherein all the local axes of rotation are linearly independent. In this case, the sensor system measures a total of three linear movements and three rotational movements, and accordingly generates 6D movement information. This makes possible even more precise statements about the position, orientation and movement in space of the associated vehicle wheel during movement.

Also preferred is a development in which the sensor system is also designed to measure a magnetic field strength at a measurement location in the electromechanical system with respect to at least a first local magnetic field measurement direction and a second local magnetic field measurement direction that are linearly independent. By measuring the magnetic field strength, the earth's magnetic field can be measured, and, in particular, the orientation of the electromechanical system or the associated vehicle wheel relative to the earth's magnetic field can be determined.

A sub-variant of the above development provides that the sensor system is furthermore designed to measure the magnetic field strength at the measurement location in the electromechanical system with respect to a third local magnetic field measurement direction, wherein all the local magnetic field measurement directions are linearly independent. This allows even more precise measurement of the earth's magnetic field and determination of the orientation of the electromechanical system within the earth's magnetic field.

In a preferred development, a local axis of movement and a local axis of rotation are chosen as the longitudinal axis of the electromechanical system, which also corresponds to a rotational axis of the wheel hub when the electromechanical system is assembled, in particular, wherein a local magnetic field measurement axis is also chosen as the longitudinal axis of the electromechanical system. The rotational speed (or speed of rotation) of the associated wheel can be directly determined via the local axis of rotation along the rotational axis of the wheel hub. A current sideways skidding movement can be easily detected via the local axis of movement along the rotational axis.

An embodiment in which the generator comprises a stator that is fixed in the electromechanical system and a rotor that is rotatable relative to the stator, wherein the rotor is designed having an imbalance element, is also advantageous. The imbalance element, due to its weight force, always remains in a lower position relative to the direction of gravity, even when the wheel is rotating. The stator, which is fixedly arranged on the electromechanical system, rotates with the wheel when the wheel rotates. This causes the rotor to move relative to the stator, which can be used to generate electrical energy. The axis of rotation of the rotor generally lies along the longitudinal axis of the electromechanical system and along the rotational axis of the wheel. Apart from the imbalance element, the electromechanical system is preferably approximately rotationally symmetrical with respect to the longitudinal axis around which the wheel hub rotates when assembled. This evens out forces on the electromechanical system caused by centrifugal force when the vehicle wheel rotates, and in particular, minimizes asymmetrical rotational forces on the electromechanical system transversely to the longitudinal axis. This reduces the mechanical stress on the electromechanical system. In particular, storage elements of the electromechanical system can be distributed around the longitudinal axis singly or in groups at uniform angular intervals and with the same radius. For example, the storage elements can be arranged opposite one another in pairs (i.e., offset by 180°) and with the same radius with respect to the longitudinal axis.

A development of the above embodiment is preferred that provides that the rotor is rotatably mounted within the stator, that one or more permanent magnets are formed on the rotor, and that one or more electromagnetic coils are formed on the stator. Due to the arrangement of the electromagnetic coils on the stator, which is fixedly arranged in the electromechanical system, no sliding contacts (such as brushes) are needed to transmit current to the (rest of the) electromechanical system, which improves wear resistance and is, in particular, low-maintenance, durable, reliable and energy-efficient. Due to the arrangement of the rotor inside the stator, ample usable space is available for the electromagnetic coils around the rotor. The permanent magnets arranged on the rotor are located axially in the region of the coils, and the imbalance element is typically located axially next to the coils. Overall, this embodiment makes a very compact and efficient design possible.

In an advantageous embodiment, the electromechanical system comprises an intermediate board and a motherboard, wherein electrical connections are established between the intermediate board and the storage system, between the storage system and the motherboard, and between the intermediate board and the motherboard, in particular, wherein electrical connections are still established between the generator and the intermediate board, and/or between the motherboard and the motor.

The intermediate board and the motherboard allow the easy establishment of the electrical connections (for supplying energy and/or for control signals and/or measurement signals) of the essential elements of the electromechanical system. Typically, the storage system is arranged between the intermediate board and the motherboard, and the electrical poles of the individual storage elements of the storage system can be aligned with the intermediate board and the motherboard and can be easily contacted from these two boards. Typically, the two circuit boards are each oriented perpendicular to the longitudinal axis, and the storage elements are oriented along the longitudinal axis. The intermediate board allows, in particular, an accumulation of the ground potentials of the generator and the storage system. The accumulated ground potential and other electronic signals can be transmitted from the intermediate board to the motherboard. The motherboard generally contains electronic elements such as processors, control units, evaluation units, sensors and communication units. Typically, the motor is connected to the motherboard.

A development of this embodiment is preferred, in which all the electrical connections of the electromechanical system between the generator, the intermediate board, the storage system, the motherboard and the motor are established by means of spring contact pins and/or rigid connecting pins. Due to the electrical connections by means of spring contact pins and rigid connecting pins a particularly high mechanical stiffness and high robustness is achieved; the spring contact pins and rigid connecting pins remain dimensionally stable even during rapid rotation of the electromechanical system and experience little or no wear. Vibrations also have little effect on the spring contact pins and rigid connecting pins. In contrast, flexible cable connections could easily fatigue and break due to centrifugal forces, especially centrifugal forces that vary in strength, or even to vibrations. It should be noted that electrical connections on the boards are typically established via conducting tracks (local conductive coatings, e.g., made of copper) applied to the board, which also remain dimensionally stable. No further electrical connections are generally required.

In a preferred development of the electromechanical system, which is designed with the intermediate board and the motherboard and the electrical connections of which between the generator, intermediate board, storage system, motherboard and motor are exclusively provided by spring contact pins and/or rigid connecting pins, it is provided that spring contact pins establish the electrical connections between the intermediate board and the storage system, and between the storage system and the motherboard, in particular, wherein spring contact pins are furthermore designed to establish the electrical connections between a generator board of the generator and the intermediate board, and/or between a motor circuit board of the motor and the main circuit board. A spring contact pin can be compressed against the force of a spring in its longitudinal direction, thereby establishing an electrical connection between its axial ends at each extension length. The spring contact pins facilitate the assembly of the electromechanical system and simultaneously establish a robust and reliable electrical connection, even under centrifugal forces. In particular, the storage elements can still be easily inserted between the already rigidly connected intermediate board and the motherboard. Likewise, the generator can easily be placed on the intermediate board and electrically contacted, or the motor can be placed on the motherboard and electrically contacted (or vice versa).

An embodiment in which the electromechanical system comprises a plurality of spring contact pins for establishing electrical connections is advantageous. A spring contact pin can be compressed against the force of a spring in its longitudinal direction, thereby establishing an electrical connection between its axial ends at each extension length. The spring contact pins are essentially rigid; only the pin held in the sheath is movable in the longitudinal direction. The spring contact pins have high resistance to heat, shock and vibration. The spring contact pins also make it easier to assemble the electromechanical system. A robust and reliable electrical connection is established, even under centrifugal forces.

Particularly preferred is an embodiment in which the electromechanical system comprises a first communication device configured for wireless communication with an electronic system of the vehicle, in particular, wherein the first communication device is designed for wireless communication by means of the BLE (= Bluetooth low energy) standard. The first communication device can be used, in particular, to pass measured data or information derived from measured data from the electromechanical system to the electronic system of the vehicle, or to pass control information from the electronic system of the vehicle to the electromechanical system. Wireless communication eliminates the need for a cable connection, and mounting the electromechanical system on the vehicle is particularly easy. A particularly low energy consumption can be achieved by means of BLE; in addition, it allows the amount of power consumed to be controlled according to the vehicle state (power-saving states) while simultaneously ensuring reliable data communication with the vehicle (despite rotation of the electromechanical system) and rapid re-establishment of the connection (fast so-called re-pairing).

Further advantageous is an embodiment in which the electromechanical system has a second communication device, configured for wireless communication with one or more external sensors, in particular, wherein the second communication device is designed for wireless communication via an RF connection or NFC connection, and, in particular, wherein the second communication device is also configured for wireless energy transmission to the one or more external sensors in the form of passive external sensors. The external sensors are located away from the electromechanical system. The second communication device allows external sensors, which are typically also arranged on the vehicle wheel, to be read, for example a sensor for measuring tire pressure. If wireless energy transfer to the external sensor is provided, the external sensor will not require its own energy supply, making the second sensor particularly simple and easy to maintain.

In an advantageous embodiment, the electromechanical system has an evaluation device for evaluating measured data from sensors of the electromechanical system and/or from external sensors. Through evaluation, particularly relevant information can be obtained from the measured data for the driving operation and for vehicle control; this information can be used in the electromechanical system itself (e.g., temperature information for energy management) or transferred to an electronic system of the vehicle where it is used (e.g., for chassis tuning or an ESP program). Typically, these particularly relevant items of information require less storage space and/or data transmission capacity than do the measured data on which they are based, or are easier to process further. The evaluation device (also called an evaluation unit) can, in particular, convert the measured data (which are usually voltage values or current values) into physical quantities (e.g., into a temperature or a speed), and if necessary, also further process the measured data or calculated physical quantities, e.g., compare them with threshold values, in accordance with a program. Often the evaluation device is connected to or integrated in a control unit (for example, for energy management or cooling management), and the control unit then also generates control commands, e.g., for activating or deactivating components, or for opening and closing a rim cover. The evaluation device (and possibly the control unit) is typically arranged on the motherboard.

In an advantageous embodiment, the electromechanical system has at least one temperature sensor. The temperature sensor can be used to detect whether the electromechanical system or a component thereof is ready for operation with regard to its temperature. If necessary, the temperature information can be used to detect whether the component concerned needs to be switched off or can be switched on again, or whether cooling measures (e.g., opening a rim cover) need to be taken or can be terminated again.

A development of this embodiment is preferred in which the electromechanical system has a plurality of temperature sensors, each measuring a temperature at a different location in the electromechanical system, in particular, wherein at least one temperature sensor is arranged on each of the generator, the motor, the storage system and a motherboard of the electromechanical system. In another variant, temperature sensors can also be provided on each of the generators, the motor and the motherboard. By using a plurality of temperature sensors at different locations, it is possible to determine for individual components of the electromechanical system at those locations whether they are ready for operation or not, and accordingly, further control of the individual components (switching on or off) can be carried out in a manner precisely tailored to the current operating situation. For example, if only the generator overheats, the electromechanical system can continue to operate, with the generator switched off and energy only being supplied from the storage system as long as enough stored electrical energy is available. If the engine is at risk of overheating, cooling measures should be taken immediately (in particular opening the rim cover) before the cooling measures (e.g., such an opening) are no longer possible. If the motherboard overheats, cooling measures should be taken and the electromechanical system should be switched off to avoid incorrect evaluations and measurements by the sensors, and also to protect the elements on the motherboard. Each component can be assigned its own first temperature threshold, above which the component can no longer operate reliably, and/or a second temperature threshold, above which the component would be irreversibly damaged. These temperature thresholds can then be taken into account in cooling management.

An embodiment is also advantageous in which the electromechanical system comprises one or more pressure sensors for measuring the pressure in the region around the electromechanical system, in particular, wherein the one or more pressure sensors can be used to measure air drag. The result of the pressure measurement can be used for vehicle control and/or for activating the rim covers.

An embodiment is also preferred in which the electromechanical system comprises at least one lighting device which is supplied with electrical energy by means of the generator and/or the storage system, in particular, wherein the at least one lighting device has one or more of the following functionalities: direction indicator, warning lighting, emergency lighting, position lighting, decorative lighting. The lighting device can generate light on the electromechanical system to make the lighting device itself more visible, or to illuminate the surrounding area. The light source is preferably an LED or an LED system. The lighting system is typically activated and/or deactivated via control commands from the vehicle's electronic system; however, it can also be activated and/or deactivated on the basis of its own measured data from the electromechanical system. For example, warning lighting or emergency lighting can be activated after acceleration above a threshold value indicative of a collision. Warning lighting can also be activated in the event of hard braking, which can be easily detected by sensors of the electromechanical system itself. Emergency lighting of the electromechanical system can be used even if the vehicle's on-board electrical system has failed, for example if the vehicle is parked at the side of the road after a breakdown or accident. Decorative lighting can, for example, display a desired brand logo of the vehicle manufacturer.

An embodiment is also advantageous in which the electromechanical system has at least one magnetically actuated switch with which the electromechanical system can be activated and deactivated in full and/or in part from outside a housing of the electromechanical system. The magnetically actuated switch (also called a magnetic switch) is then typically actuated in a workshop. The magnetic switch is located inside a housing of the electromechanical system and does not require any openings in the housing, through which dirt could enter, in order to be actuated; it is sufficient to suitably move an external magnet (for example, a rotary movement of a magnet) to or past a specific location on the housing, which is typically marked for this purpose. For example, when vehicle wheels are stored seasonally together with the electromechanical system, said system can be deactivated via the magnetic switch, and when the vehicle wheels are refitted, it is reactivated using the magnetic switch.

An embodiment is also preferred in which the electromechanical system comprises an energy control device for controlling the consumption of electrical energy, with which components and/or functions of components of the electromechanical system can be activated and deactivated. This allows the electromechanical system to be used particularly efficiently and/or increases its operational readiness. Unnecessary emptying of the storage system is avoided, or energy consumption is limited, possibly also in stages, to a few particularly important functions when the storage level is lower. The energy control device can, for example, provide as needed a temporary partial or complete shutdown of the first communication unit (power-saving modes in BLE), such as shutting down the transceiver during communication pauses. Shutting down components, especially communication devices, may be provided, in particular, during longer periods when the vehicle is stationary ("parking"). Depending on the energy supply and/or generator output, shorter or longer data transmission intervals can be provided for communication units. In addition, temperature- and speed-dependent control of the actuator can be provided. The vehicle's electronic system can activate a sleep mode of the electromechanical system via a transmitted control command (e.g., when the vehicle is parked), in which the electromechanical system is largely deactivated. The sleep state can if desired also be ended via an external command from the vehicle's electronic system. Preferably, however, the (necessary) end of the sleep state is set by the electromechanical system itself, for example when it detects wheel movement.

A development of this embodiment is particularly preferred in which the energy control device is configured such that if a first threshold of currently stored electrical energy in the storage system is undershot, one or more components and/or functions of components are deactivated, and/or if a second threshold of current power of the generator is exceeded, one or more deactivated components or functions of components are reactivated. If the first threshold is undershot, the remaining energy can be reserved for any remaining particularly important components or functions by switching off components or functions. If the second threshold is exceeded, it becomes apparent that (presumably) sufficient new energy is available again to be able to reactivate components or functions. Alternatively or additionally, it may be provided that the electromechanical system can be put into an energy-saving mode (sleep mode) via an external command (e.g., from an electronic control unit of the vehicle), in which one or more components and/or functions of components are deactivated. If the second threshold is exceeded, the one or more deactivated components or functions of components can be reactivated.

In an advantageous embodiment, the electromechanical system has a housing with an external thread for screwing into the wheel hub of the vehicle. The external thread on the housing allows easy positioning and fastening of the electromechanical system in the wheel hub. The screw connection can be secured if desired, for example with a lock nut also arranged on the external thread, with the lock nut clamped against an upper stop of the wheel hub.

Also preferred is an embodiment in which the storage system comprises rechargeable batteries and/or high-capacitance capacitors, in particular, electrolytic capacitors. With rechargeable batteries a large amount of energy can be stored in a small space even for extended periods; elongated batteries with opposing poles at the ends are preferred, for example rechargeable AA batteries. With capacitors charging and discharging can be particularly fast, making a particularly high number of charging cycles possible. A high-capacitance capacitor for the invention typically has a capacitance of at least 100 µF, often at least 0.1 F, preferably at least 1 F, and particularly preferably at least 10 F. In particular, so-called Super Caps can be used.

Another preferred embodiment of the electromechanical system according to the invention provides that the electromechanical system has a housing comprising a longitudinal wall extending substantially along the longitudinal axis, wherein at least one passage point for the actuator is provided in the longitudinal wall, wherein in the region of the passage point the actuator has a central section which extends along the longitudinal axis and is arranged in a transverse direction between an inner wall part and an outer wall part of the longitudinal wall, wherein the inner wall part and the outer wall part extend in parallel with the longitudinal axis, are spaced apart from each other in the transverse direction and are arranged offset from one another other along the longitudinal axis, and wherein in the region of the passage point the actuator has an inner collar and an outer collar, which are designed such that the inner collar provides axial support on the inner wall part and the outer collar provides axial support on the outer wall part.

### Uses according to the invention

The scope of the present invention also includes the use of at least two electromechanical systems according to the invention as described above, wherein the at least two electromechanical systems are fixedly arranged in the central cavities of wheel hubs of at least two vehicle wheels, in particular, steered vehicle wheels, of a vehicle, wherein each electromechanical system uses one or more sensors of the electromechanical system to capture measured data relating to the current state of the vehicle wheel, wherein, by means of a first communication device of the electromechanical system, these measured data or information obtained from these measured data are wirelessly passed on to an electronic system of the vehicle, and wherein the vehicle's electronic system takes into account the forwarded measured data or information when adjusting vehicle characteristics and/or controlling the vehicle. The electromechanical systems can easily provide measured data or information derived from the measured data for the vehicle's electronic system. The electromechanical systems exhibit a high level of operational readiness and can be compact, thus providing installation space for sensors and other elements that may be desired. In addition, the motor and actuator of each electromechanical system can be used to move a coupled movable element, in particular, to open and close a rim cover. In order to activate a rim cover, measured data or information derived therefrom from the local electromechanical system and/or other electromechanical systems, in particular, temperature information and/or speed information and/or dynamic pressure information ("airstream"), can be evaluated. One or more sensors can be set up wholly or partially by a sensor system described above.

A variant of the use according to the invention is particularly advantageous in which the electronic system of the vehicle uses the forwarded measured data or information to operate an electronic stability program (= ESP) of the vehicle. The ESP can be operated exclusively using the measured data and information forwarded by the electromechanical systems, or said forwarded measured data and information increase the safety level of a conventional ESP through additional redundancy. Alternatively or in addition to ESP, the forwarded measured data or information can also be used to operate an adaptive suspension control system, for example.

Further advantages of the invention can be found in the description and the drawings. Likewise, according to the invention, the aforementioned features and those which are to be explained below can each be used individually or together in any desired combinations. The embodiments shown and described are not to be understood as an exhaustive list, but, rather, have an exemplary character for the description of the invention.

### BRIEF DESCRIPTION OF THE DRAWINGS

Detailed description of the invention and drawings:

FIG. 1 is a schematic side view of an exemplary embodiment of the electromechanical system according to the invention;

FIG. 2 is a schematic longitudinal section through the embodiment in FIG. 1;

FIG. 3 is a highly schematic lateral view of the embodiment in FIG. 1 without the housing, coupling device and actuator, which illustrates electrical connections established by rigid connecting pins and spring contact pins;

FIG. 4 is a highly schematic cross-sectional view of the embodiment in FIG. 1 perpendicular to the longitudinal axis, which illustrates the structure of the actuator;

FIG. 5 is a highly schematic longitudinal sectional view of the embodiment in FIG. 1, which illustrates a passage point for the actuator in the housing;

FIG. 6 is a highly schematic view of an electromechanical system according to the invention in an exemplary embodiment installed in the cavity of a wheel hub of a vehicle wheel, with the rim cover mounted in the closed position;

FIG. 7 shows the installed electromechanical system from FIG. 6, with the rim cover in the open position;

FIG. 8 is a highly schematic plan view of an exemplary embodiment of a vehicle wheel with the electromechanical system installed, comprising a multi-part rim cover;

FIG. 9 schematically shows a plan view of a motherboard of an electromechanical system according to the invention in an exemplary embodiment; and

FIG. 10 shows a highly schematic lateral view of a vehicle, on each of whose wheels electromechanical systems according to the invention are installed, in an example use according to the invention.

### DETAILED DESCRIPTION OF THE PREFERRED EMBODIMENTS

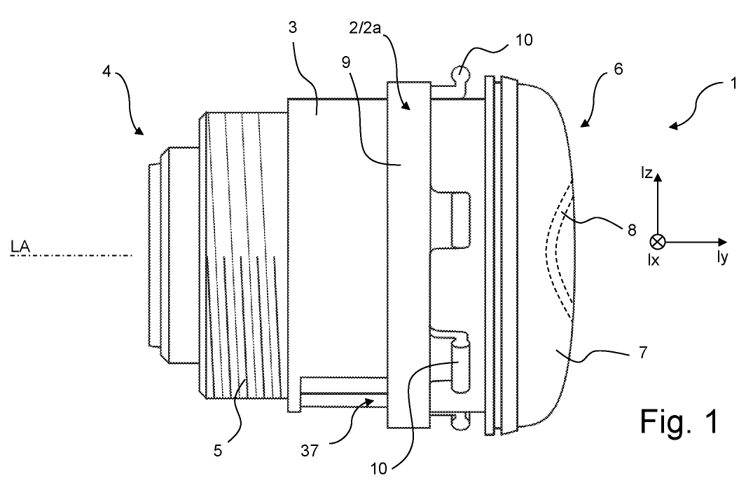

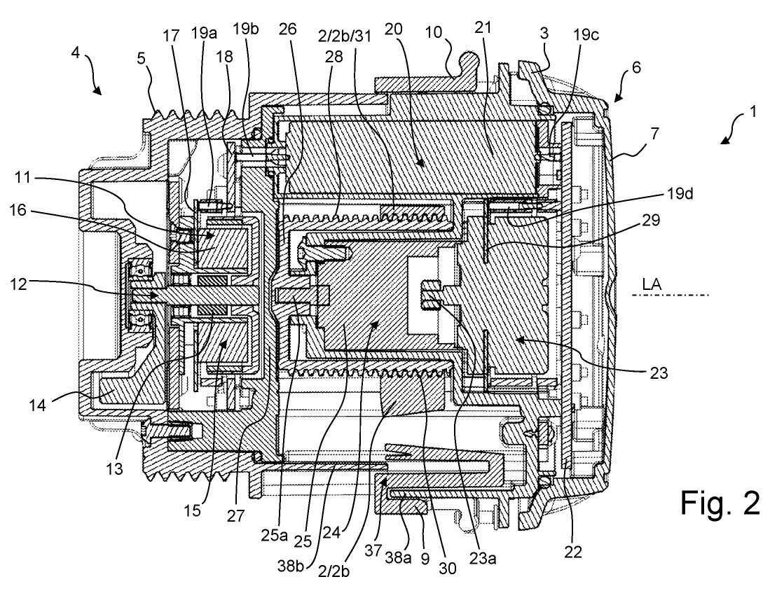

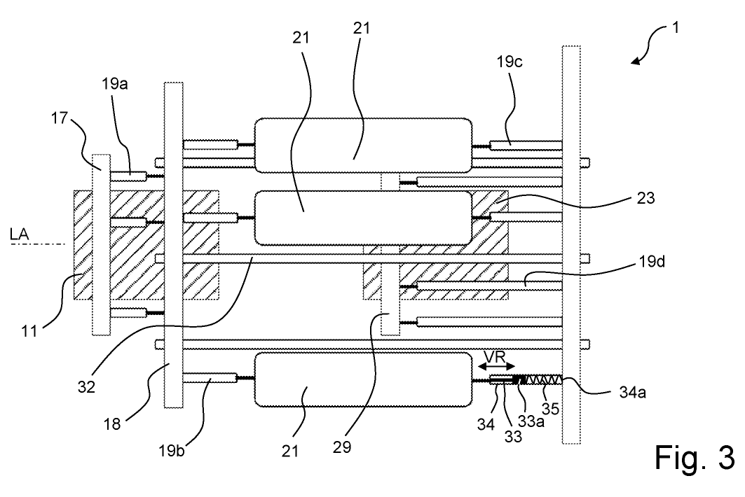

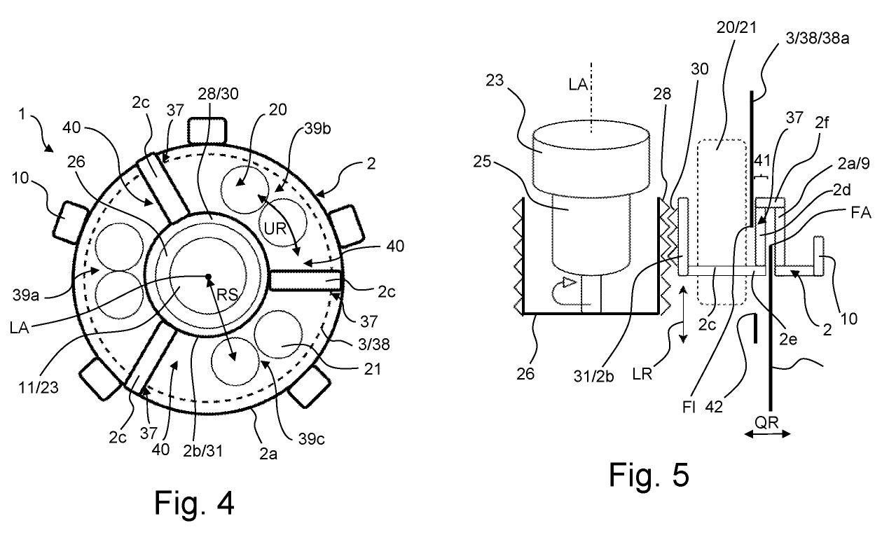

FIGS. 1 to 5 show an electromechanical system 1 according to the invention in an exemplary embodiment. The figures schematically illustrate various aspects of the electromechanical system 1. FIG. 1 shows a lateral view from the outside; FIG. 2 shows a longitudinal section through all the components; FIG. 3 shows a lateral view of an inner part of the electromechanical system 1, in particular, without the housing; FIG. 4 shows a cross-section in the region of the actuator, and FIG. 5 shows another longitudinal section in the region of a connecting structure 2c of the actuator 2.

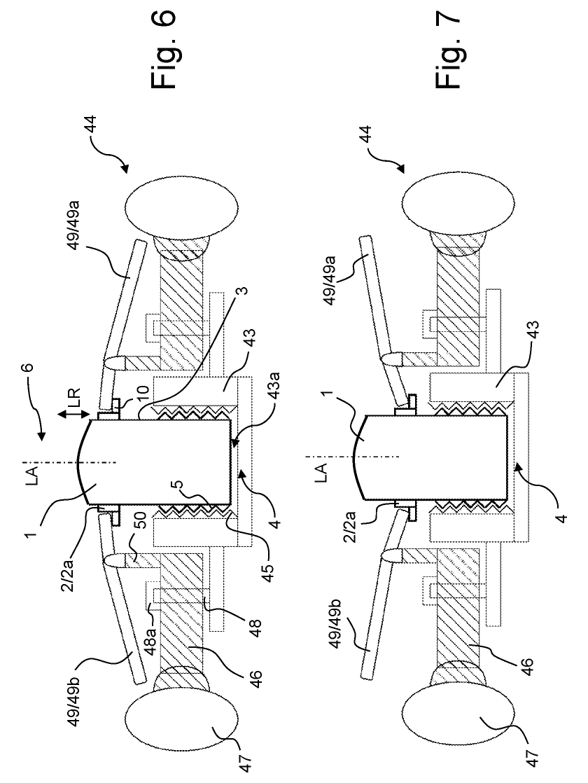

As can be clearly seen in FIG. 1, the electromechanical system 1 in the embodiment shown has an essentially cylindrical housing 3, which forms an external thread 5 in the region of a front end 4, with which thread it can be screwed into a corresponding mating thread of a wheel hub (not shown in detail; cf. FIG. 6, for example). In the area of a rear end 6, the housing 3 forms an end cap 7. If desired, a lighting device 8 can be integrated into the end cap 7 (shown as a dashed line). An outer part 2a of the actuator 2 is movable along a longitudinal axis LA of the electromechanical system 1; the actuator 2 is driven by a motor which is arranged inside the housing 3 (hidden in FIG. 1; cf. FIG. 2 or FIG. 5, for example, in this regard). The outer part 2a forms a circumferential ring 9, from which tabs 10 project. Swivel flaps of a rim cover can be coupled to the tabs 10 (see, for example, FIG. 6 in this regard).

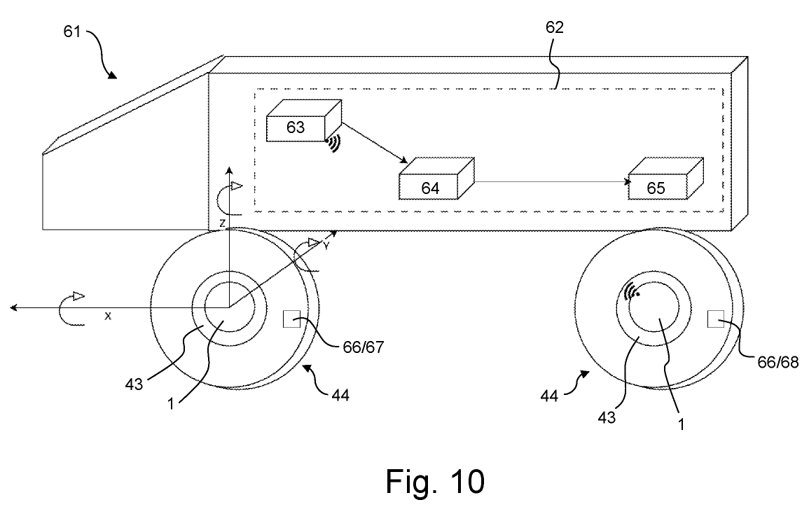

Linear movements, angular movements and magnetic field measurements with respect to the local axes lx, ly and lz can be carried out here with the aid of a sensor unit included in the electromechanical system 1 (see FIG. 9). It should be noted that the local axes lx, ly, lz move with the electromechanical system 1, i.e., also by a rotational movement of a vehicle wheel to which the electromechanical system 1 is fastened, or by vibrations at the vehicle wheel. The local axes lx, ly, lz accordingly represent local (linear) axes of movement, local axes of rotation and local magnetic field measurement directions for associated measurements; usually, measured data are converted to the vehicle axles (see FIG. 10 in this regard). The local axis ly lies on the longitudinal axis LA in this case, which simultaneously represents the rotational axis of the vehicle wheel when the electromechanical system 1 is in the installed state. The local axes lx, ly, lz are perpendicular to one another.

In the longitudinal section in FIG. 2, the components or component parts of the electromechanical system 1 lying inside the housing 3 can be seen along the longitudinal axis LA.

A generator 11 is arranged at the front end 4. Permanent magnets 13 are fixedly arranged on a radially inner rotor 12, which is located on the longitudinal axis LA. In addition, an imbalance element 14 is rigidly attached to the rotor 12. The rotor 12 can rotate about the longitudinal axis LA relative to a stator 15, which is fixedly arranged in the electromechanical system 1. The stator 15 has electromagnetic coils 16. When the wheel (not shown, cf. FIG. 10, for example, in this regard) in which the electromechanical system 1 is permanently installed rotates when the associated vehicle is traveling, the imbalance element 14 is held in a lower position by gravity. Accordingly, the stator 15 then rotates around the rotor 12 together with the vehicle wheel. The permanent magnets 13 induce an electric current in the electromagnetic coils 16. This electric current is provided at a generator board 17.

The generator board 17 is connected to an intermediate board 18 by a plurality of spring contact pins 19a in order to transfer electrical energy to the intermediate board 18 and also to transmit control signals. Here, the generator 11 passes through the intermediate board 18.

Between the intermediate board 18 and a motherboard 22, which is arranged at the rear end 6 of the electromechanical system 1, is a storage system 20 for storing electrical energy, which in this case comprises six storage elements 21 (in FIG. 2, only one of the storage elements 21 can be seen; however, cf. FIG. 4 in this regard). The storage elements 21 are approximately cylindrical and lie in parallel with the longitudinal axis LA in a radially outer region within the housing 3. The storage elements 21 are in each case electrically connected to the motherboard 22 at one end pole via spring contact pins 19b of the intermediate board 18 and at the other end pole via spring contact pins 19c. The storage elements here are rechargeable batteries, e.g., Li-ion batteries.

The storage elements 21 surround a motor 23 and a coupling device 24, which are arranged in a radially inner region of the housing 3. The coupling device 24 here comprises a transmission 25, which reduces the rotation of a shaft 23a (also called the motor shaft) of the motor 23 and transmits it to a shaft 25a (also called the transmission shaft) of the transmission 25. In addition, the coupling device 24 includes a spindle 26 which is rigidly coupled to the transmission shaft 25a. The spindle 26 can rotate about the longitudinal axis LA on a bearing 27. The spindle 26 is cup-shaped here and surrounds the transmission 25. An external thread 28 is formed on the radial outer side of the cup-shaped spindle 26. The motor 23 is designed comprising a motor board 29. The motor board 29 is electrically connected to the motherboard 22 via spring contact pins 19d. Via these electrical connections, the motor 23 can obtain electrical energy and receive control commands.

An inner part 2b of the actuator 2 is screwed onto the external thread 28 of the spindle 26. This inner part 2b is designed as a circumferential ring 31 and has a matching internal thread 30. The inner part 2b is rigidly connected to the outer part 2a of the actuator 2 via connecting elements (not fully visible in FIG. 2; however, cf. FIG. 4 in this regard). The actuator 2 is held overall in the electromechanical system 1 so that it cannot rotate, here at the passage point 37 of the housing 3 (cf. also FIG. 4 in this regard). When the spindle 26 inside the electromechanical system 1 is rotated about the longitudinal axis LA by means of the motor 23 and the transmission 25, the inner part 2b of the non-rotatable actuator 2 with its internal thread 30 moves along the external thread 28 of the spindle 26 in the axial direction, i.e., along the longitudinal axis LA. As a result, the actuator 2 as a whole is linearly moved. The tabs 10 on the outer part 2a of the actuator 2 can then be used to actuate a rim cover (cf. FIG. 6 and FIG. 7 in this regard).

Due to the fact that the storage system 20 and, in particular, the storage elements 21 radially enclose the outside of the motor 23, the motor is protected from heat radiation acting on the housing 3 from radially outside. The storage system 20 shields against heat radiation and also temporarily stores incoming heat so that such heat (at least if the exposure time is not too long) does not reach the motor 23, which remains ready for operation. The storage elements 21 generally extend in the axial direction over the vast majority of the axial length of the motor 23 (at least 75% of the axial length of the motor 23, preferably at least 90%). In addition, the coupling device 24 is arranged axially on the side of the motor 23 facing the front end 4, i.e., between the generator 11 and motor 23. Heat radiation and introduced heat, which passes from the front end 4 to the electromechanical system 1, is then shielded or temporarily stored by the generator 11 and the coupling device 24. In general, the storage elements 21 also extend over the vast majority of the coupling device 24 in the axial direction (at least 75% of the length of the transmission 25, preferably at least 90%). This also protects the motor 23 from overheating and keeps it highly operational. Similarly, the motherboard 22 is also protected from heat penetrating from the front end 4. It should be noted that in practice, when the electromechanical system 1 is installed on the wheel hub of a vehicle wheel, the front end 4 faces the brakes and is therefore the most exposed to the heat of the brakes. In addition, the wall of the wheel hub, into which the electromechanical system 1 is inserted, typically passes some of the heat from the brakes, leading to heat being applied to the electromechanical system from radially outside. The electromechanical system 1 according to the invention can effectively counteract this heat input by radially shielding the particularly sensitive components, that is to say the motor 23 and the motherboard 22, by means of the storage system 20 and, as shown here, preferably also axially shielding them by means of the generator 11 and the coupling device 24.

The schematic representation in FIG. 3, that is not to scale, shows the electrical connections of the components of the electromechanical system 1 that are relevant for the electrical functions.

As already mentioned, the generator board 17 of the generator 11 is electrically connected to the intermediate board 18 via spring contact pins 19a, in particular, for the transmission of electrical energy and control signals, and possibly also sensor signals. The storage elements 21 are electrically connected to the intermediate board 18 via spring contact pins 19b, and to the motherboard 22 via spring contact pins 19c. The motor board 29 of the motor 23 is electrically connected to the motherboard 22 via spring contact pins 19d, in particular, for the transmission of electrical energy and control signals, and possibly also sensor signals. In addition, the intermediate board 18 and the motherboard 22 are electrically connected via electrically conductive, rigid connecting pins 32 (also called rigid connecting rods) for the transmission of electrical energy and for the exchange of control commands, and possibly also sensor signals.

The boards 17, 18, 22, 29 are provided with conducting tracks (not shown in detail), on each of which electrical contact is made (not shown in detail).

Electronic elements such as control devices, sensors and wireless communication devices are arranged on the motherboard 22 (cf. also FIG. 9 in this regard).

The spring contact pins 19a-19d, shown by way of example at the bottom right of FIG. 3, are each constructed with a pin 33 which is movable in a metal sleeve 34 (also called a sheath) in a displacement direction VR. The displacement direction VR is parallel to the longitudinal axis LA in this case. The pin 33 is pre-tensioned into an extended position by a spring 35 arranged in the sleeve 34. The spring 35 can, for example, be designed as a metallic helical spring that rests between an end stop 34a of the sleeve 34 and a thickened end section 33a of the pin 33. Against the force of the spring 35, the pin 33 can be inserted or pressed into the sleeve 34. The sleeve 34 is typically rigidly anchored in the region of its end stop 34a on a board 17, 18, 22, 29 and is thus electrically contacted. The pin 33 presses on a structure (e.g., a storage element 21 in this case) by means of the spring 35, thereby electrically contacting this structure. The pin 33 and sleeve 34 are each electrically conductive (preferably by being made of metal) and rest against one another (here in the region of the thicker end portion 33a) so that electrical contact can be made between their ends via the spring contact pin 19a-19d. The spring contact pins facilitate electrical contact during the assembly of the electromechanical system 1.

In the embodiment shown, all the electrical connections between the generator 11, the motor 23, the storage elements 21, the intermediate board 18 and the motherboard 22 are established via spring contact pins 19a-19d and rigid connecting pins 32. These electrical connections are relatively insensitive to the centrifugal forces that occur when the electromechanical element 2 rotates together with the vehicle wheel.

The structure of the electromechanical system 1 is schematically shown in FIG. 4 in a cross-section perpendicular to the longitudinal axis LA in an axially central region and in FIG. 5 in a longitudinal section along the longitudinal axis LA. It should be noted that the representation in FIG. 5 focuses on the region to the right of the longitudinal axis LA (i.e., the region to the right of the longitudinal axis LA is not shown for the sake of simplicity), and the two FIGS. 4 and 5 are not to scale.

The motor 23 and the transmission 25 below them are arranged centrally on the longitudinal axis LA, to which transmission the spindle 26 is coupled (see also FIG. 2). The external thread 28 of the spindle 26 engages with the internal thread 31 of the radially inner part 2b of the actuator 2. The inner part 2b is formed with a circumferential ring 31. The inner part 2b is rigidly connected to the radially outer part 2a of the actuator 2 by means of three connecting elements 2c of the actuator 2 in this case. The outer part 2a of the actuator 2 is also formed with a circumferential ring 9.

The connecting elements 2c pass through a longitudinal wall 38 (shown as a dashed line) of the housing 3 at three passage points 37 in this case. Accordingly, the outer part 2a of the actuator 2 lies outside the housing 3. On the outer part 2a, five tabs 10 are arranged, to which a rim cover can be hingedly connected (see e.g., FIG. 6 in this regard). At the passage points 37, the connecting elements 2c laterally abut the housing 3 in the circumferential direction of the housing 3 so that the actuator 2 is unable to rotate with respect to the longitudinal axis LA. However, the actuator 2 can be moved in the longitudinal direction LR, i.e., parallel to the longitudinal axis LA, by rotation of the spindle 26 about the longitudinal axis LA.

The storage elements 21 of the storage system 20 for electrical energy are arranged in the radial region between the inner part 2b of the actuator 2 and the longitudinal wall 38 of the housing 3. In the illustrated design, three groups 39a, 39b, 39c of storage elements 21 are provided, each comprising two storage elements 21. All the storage elements 21 are arranged here on a uniform radius RS (measured from the longitudinal axis LA to the center of each storage element 21). The groups 39a-39c are evenly distributed in the circumferential direction UR. The storage elements 21 of a group 39a-39c are adjacent to one another in the circumferential direction UR; however, in the circumferential direction UR, there is a clear space 40 between adjacent groups 39a, 39b, 39c. Some of the storage elements 21 are correspondingly, in this case in accordance with how the groups are arranged, spaced apart from one another in the circumferential direction UR by the spaces 40. A connecting element 2c projects radially through each gap 40.

At each passage point 37, the longitudinal wall 38 has a radially inner wall part 38a (which is arranged at the top in FIG. 5) and a radially outer wall part 38b. The two wall sections 38a, 38b running along the longitudinal axis LA are spaced apart from each other in the radial direction, also called transverse direction QR, by a gap 41. Furthermore, the wall parts 38a, 38b are offset from one another in the longitudinal direction LR, here without any overlap in the longitudinal direction (alternatively, the wall parts 38a, 38b may be partially offset from one another, i.e., arranged with a partial overlap in the longitudinal direction LR (not shown in detail)). The free ends FI of the inner wall part 38a (“inner free end” FI) and the free end FA of the outer wall part 38b (“outer free end” FA) are opposite one another.

In the gap 41 between the wall parts 38a, 38b is a central portion 2d of the actuator 2, which is aligned in parallel with the wall portions 38a, 38b and overlaps the free ends FI, FA (in the travel position of the actuator 2 shown, and also in all other possible travel positions). With an inner collar 2e, the actuator 2 overlaps the inner free end FI in the transverse direction QR, and with an outer collar 2f, the actuator 2 overlaps the outer free end FA in the transverse direction QR. The inner collar 2e transitions into the remaining connecting element 2c, which extends to the inner part 2b. The outer collar 2f transitions into the outer part 2a of the actuator 2, which here comprises a circumferential ring 9. The inner collar 2e and the outer collar 2f, together with the free ends FA, FI in the form of stops, limit the travel path of the actuator 2 in the longitudinal direction LR; however, if desired, separate stops 42 for the actuator 2 can also be provided to limit the travel path.

The central part 2d and the two collar parts 2e, 2f largely block the passage point 37 so that the interior of the housing 3 is protected from contamination.

FIG. 6 and FIG. 7 are schematic longitudinal sections along the longitudinal axis LA illustrating an exemplary electromechanical system 1, similar to that shown in FIG. 1 to 5, installed in a wheel hub 43 for a vehicle wheel 44.

The wheel hub 43 is rigidly connected to a vehicle shaft in a manner not shown in detail, via which shaft the driving force is transmitted to the vehicle wheel 44. The wheel hub 43 therefore rotates during driving, and with it the electromechanical system 1.

The wheel hub 43 forms an approximately cylindrical, central cavity 43a. The electromechanical system 1 is screwed into an internal thread 45 by means of the external thread 5 of its housing 3, which internal thread forms the wheel hub 43 on the lateral wall of the cavity 43a, and is fixed in the screwed-in state in a manner not shown in detail, in particular, also non-rotatably fixed.

A rim 46 of the vehicle wheel 44 is fixed to the wheel hub 43. The rim 46 is fixed by means of screw bolts 48 fixed to the wheel hub 43, which project through the rim 46, with cap nuts 48a being screwed onto the ends of each of the screw bolts 48 (in FIGS. 6 and 7 the rim 46 is shown slightly elevated from the wheel hub 43 to better differentiate it from the wheel hub 43; in practice, however, the rim 46 is clamped onto the wheel hub 43 by the cap nuts 48a). A tire 47 is arranged on the rim 46.

The outer part 2a of the actuator 2 is movable in the longitudinal direction LR on the housing 3 of the electromechanical system 1 (cf., for example, FIG. 5 in this regard). A rim cover 49 is coupled to the tabs 10 of the actuator 2. The rim cover 49 comprises multiple pieces in this case and here comprises a plurality of swivel flaps 49a, 49b. Each radially inner end of the swivel flap 49a, 49b is hingedly connected to a tab 10. In addition, each swivel flap 49a, 49b is held by a swivel holder 50 and can be pivoted about said holder about a local pivot axis that is perpendicular to the longitudinal axis LA. The swivel holder 50 is rigidly fastened to the rim 46.

FIG. 6 shows the rim cover 49 in a closed position; this includes a position of the actuator 2 moved upward in the longitudinal direction LR (toward the rear end 6 of the electromechanical system 1). The swivel flaps 49a, 49b are folded down (with their radially outer ends) onto the rim 46. In this position, the vehicle wheel 44 has particularly low drag during driving. However, only a small amount of cooling airstream reaches the rim 46 and, through openings in the rim 46 (openings not shown in detail), passes under the rim 46.

FIG. 7 shows the rim cover 49 in an open position; this includes a position of the actuator 2 moved downward in the longitudinal direction LR (toward the front end 4 of the electromechanical system 1). The swivel flaps 49a, 49b are folded away from the rim 46 (by their radially outer ends). In this position, a particularly large amount of cooling airstream reaches the rim 46. However, this increases the drag of the vehicle wheel 44.

It should be noted that braking while driving causes the wheel hub 43 to heat up from below (in FIG. 6 and FIG. 7) and pass a significant portion of this heat to the electromechanical system 1. Heat is introduced axially from below into the front end 4 of the electromechanical system 1 but also from the radial outside into a part of the electromechanical system 1 near the front end 4, especially where the electromechanical system 1 overlaps the wheel hub 43 in the axial direction. However, the internal structure of the electromechanical system 1 provides good protection for the particularly sensitive motor and the motherboard (see e.g., FIG. 2) against heat input from radially outside (and also from below), thus achieving a high level of operational readiness.

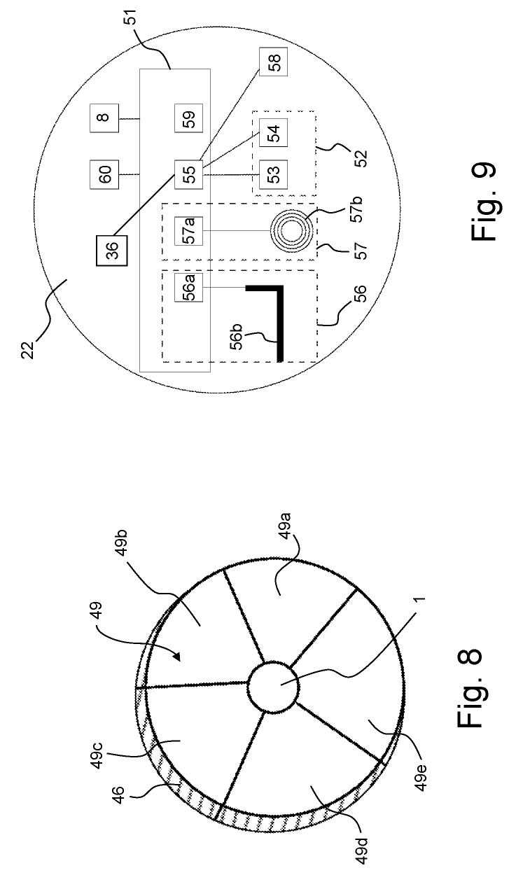

FIG. 8 once again shows a perspective view, almost along the longitudinal axis, of a rim cover 49 with in this case five swivel flaps 49a-49e, which can in the manner shown above be pivoted toward and away from the rim 46 by means of the electromechanical system 1.

FIG. 9 shows a schematic plan view of a motherboard 22 for an electromechanical system according to the invention.

The motherboard 22 here comprises a main processor 51, in which various electronic functions are provided whether in full or in part, in particular, control functions for other elements on the motherboard 22 and components of the electromechanical system outside the motherboard 22. In particular, the main processor 51 can be used to activate the motor that actuates the actuator to actuate the rim cover. In addition, the main processor 51 monitors and controls the charging and discharging processes of the storage system, and the generator is monitored and controlled.

A sensor system 52 (also called a sensor unit) is provided on the motherboard 22 in this case. This comprises a 6D motion sensor 53 in this case, with which linear movements with respect to three orthogonal local axes of movement and angular movements with respect to three orthogonal local axes of rotation can be determined; the three local axes of movement and the three local axes of rotation are selected to be equal to one another. The 6D motion sensor 53 is designed for this purpose with a combination of accelerometer and gyroscope. In addition, the sensor system 52 here also comprises a magnetometer 54, with which the magnetic field strength of the earth's magnetic field at the location of the magnetometer 54 can be measured along three orthogonal local magnetic field measurement directions. The local magnetic field measurement directions correspond here to the local directions of movement and axes of rotation. The measured data from the sensor system 52 are passed on to an evaluation device 55, which is integrated here into the main processor 51. The evaluation device 55 performs a coordinate transformation for the measured data received from the sensor system 52 in order to convert them into the vehicle's coordinate system (see FIG. 10 in this regard). In addition, the evaluation unit 55 converts the measured data into physical quantities (i.e., linear velocity, angular velocity and magnetic field strength).

In addition, a temperature sensor 58 is provided on the motherboard 22. Its measured data are also forwarded to the evaluation unit 55. The evaluation unit 55 also receives measured data from additional temperature sensors arranged on the generator, the storage system and the motor (not shown in detail).

A pressure sensor 36 is also provided on the motherboard 22, which can be used to measure ambient pressure ("air pressure"). Its measured data are also forwarded to the evaluation unit 55.

Mounted on the motherboard 22 in this case is also a lighting device 8, which is activated via the main processor 51. The lighting device 8 typically comprises a plurality of LEDs distributed on the motherboard 22 and connected to light-guiding elements (e.g., Plexiglas structures) that lead to the end cap of the electromechanical system (not shown in detail; however, cf. FIG. 1 in this regard).

In order to receive control commands from the vehicle, or to pass measured data or information determined from the measured data to the vehicle, a first communication device 56 is provided on the motherboard 22. The electronic part 56a of the first communication device 56 is integrated into the main processor 51. In addition, the first communication device 56 has an antenna 56b. The first communication device 56 is designed here for Bluetooth low energy (BLE) communication.

To obtain measured data from an external sensor, which is integrated, for example, in the valve of the tire of the vehicle wheel, or to transfer energy to the external sensor, a second communication device 57 is provided on the motherboard 22. The electronic part 57a of the second communication device 57 is integrated into the main processor 51. In addition, the second communication device 57 has an antenna 57b. The second communication device 57 is designed here for Bluetooth or NFC/RF communication.

An energy control device 59 is also integrated into the main processor 51. This, in particular, decides which components and elements or functions of components and elements are activated, partially activated or deactivated at any given time. This allows the available electrical energy, generated by the generator and/or stored in the storage system, to be used in such a way as to achieve high operational readiness of the essential functions of the electromechanical system.

In addition, a magnetically actuatable switch 60 (also called a magnetic switch) is arranged on the motherboard 22, which can be externally actuated (i.e., from outside the housing of the electromechanical system) by a magnet. The electromechanical system can be activated and deactivated either in full or in part by means of the magnetic switch.

The electromechanical system, in particular, the main processor 51 of the motherboard 22, can serve as a data aggregator for measured data from the sensors 53, 54, 58, 36 or also from external sensors or information obtained therefrom, and transmit them to the vehicle-side electronic system by means of the first communication device 56 (see also FIG. 10 in this regard). The motherboard 22 often also includes a DC-DC converter (not shown in detail).

FIG. 10 schematically shows a vehicle 61, on the wheel hubs 43 of the vehicle wheels 44 electromechanical systems 1 according to the invention are installed. The vehicle 61 illustrated here by way of example has four vehicle wheels 44, two of which can be seen in the view in FIG. 10 (the other two vehicle wheels on the side of the vehicle facing away from the viewer in FIG. 10 would be essentially hidden and are therefore not shown in detail). In the example presented, each of the four vehicle wheels 44 of the vehicle 61 is fitted with an electromechanical system 1; it is generally preferred to equip all the vehicle wheels 44 of a vehicle 61 with electromechanical systems 1 according to the invention. It should be noted that in other uses, only some of the vehicle wheels of a vehicle may be equipped with electromechanical systems, with the vehicle wheels of only some of the axles of the vehicle typically being equipped with electromechanical systems, preferably including at least the steered axle (not shown in detail).

The vehicle 61 can be assigned vehicle axes x, y, z, shown here on one of the wheels 44. The x-axis corresponds to the (horizontal) forward direction of travel of the vehicle 61; as an axis of rotation, this corresponds to the roll axis of a vehicle wheel 44. The y-axis corresponds to the horizontal direction perpendicular to the forward direction of travel; as an axis of rotation, this corresponds to the pitch axis. The z-axis corresponds to the vertical axis perpendicular to the direction of forward travel; as an axis of rotation, this corresponds to the yaw axis. The measured values determined on an electromechanical system 1 or on a vehicle wheel 44 are typically converted to the vehicle axes by a coordinate transformation.

In the illustrated example, external sensors 66 are arranged remotely from the electromechanical systems 1 on the vehicle wheels 44, which, in the illustrated example, are designed as tire pressure sensors 67 and tire temperature sensors 68. These transmit measured data to the second communication unit of each electromechanical system 1 via NFC/RF communication (see FIG. 9 in this regard). In addition, the second communication device also wirelessly transmits energy to the external sensors 66 in this case, which can therefore be passive, i.e., without their own power supply. In other embodiments, the external sensors 66 can when required also determine other physical quantities of interest, for example ambient brightness for activating and deactivating a lighting device as position lighting (not shown in detail).

The electromechanical systems 1 of the vehicle wheels 44 use each of their first communication devices (see FIG. 9 in this regard) to communicate with an electronic system 62 of the vehicle 61 via a vehicle-side communication device 63; this is configured here for BLE. In this process, measured data from the sensor system and/or other sensors of each of the electromechanical systems 1 and/or external sensors, or information obtained therefrom, are transmitted to the electronic system 62 of the vehicle 61. This allows the current state (especially the state of motion) of the electromechanical systems 1 or the vehicle wheels 44 to be communicated to the electronic system 62 of the vehicle 61. An ESP control unit 64 of the electronic system 62 of the vehicle 61 evaluates this measured data or information (at least partially) and derives commands therefrom for controlling the vehicle 61. In particular, control commands are generated for the brake control unit 65 and passed thereto. The brake control unit 65 then activates the brakes of the vehicle 61, thereby implementing, for example, an anti-lock braking system. Likewise, for example, chassis tuning can be activated (not shown in detail).

### LIST OF REFERENCE SIGNS

1 electromechanical system

2 actuator

2a outer part of the actuator

2b inner part of the actuator

2c connecting elements of the actuator

2d central portion of the actuator

2e inner collar of the actuator

2f outer collar of the actuator

3 housing

4 front end

5 external thread

6 rear end

7 end cap

8 lighting device

9 circumferential ring (outer part of the actuator)

10 tab

11 generator

12 rotor

13 permanent magnets

14 imbalance element (unbalanced component)

15 stator

16 electromagnetic coils

17 generator board

18 intermediate board

19a spring contact pins (generator board to intermediate board)

19b spring contact pins (storage elements to intermediate board)

19c spring contact pins (storage elements to motherboard)

19d spring contact pins (motor board to motherboard)

20 storage system

21 storage element

22 motherboard

23 motor

23a shaft of the motor

24 coupling device

25 transmission

25a shaft of the transmission

26 spindle

27 bearing for the spindle

28 external thread (on the spindle)

29 motor board

30 internal thread (on the inner part of the actuator)

31 circumferential ring (inner part of the actuator)

32 rigid connecting pin

33 (movable) pin

33a thicker end portion of the pin

34 sleeve (sheath)

34a end stop of the sleeve

35 spring

36 pressure sensor (on the motherboard)

37 passage point

38 longitudinal wall

38a inner wall part of the longitudinal wall

38b outer wall part of the longitudinal wall

39a-39c groups of storage elements

40 space (between groups of storage elements)

41 gap (between the inner wall part and outer wall part)

42 separate stop

43 wheel hub

43a central cavity (wheel hub)

44 vehicle wheel

45 internal thread (wheel hub)

46 rim

47 tires

48 screw bolts

48a cap nut

49 rim cover

49a-49e swivel flaps (of the rim cover)

50 swivel holder

51 main processor

52 sensor system

53 6D motion sensor

54 magnetometer

55 evaluation device

56 first communication device

56a electronic part (first communication device)

56b antenna (first communication device)

57 second communication device

57a electronic part (second communication device)

57b antenna (second communication device)

58 temperature sensor

59 energy control device

60 magnetically actuated switch

61 vehicle

62 electronic system of the vehicle

63 vehicle-side communication device

64 ESP control unit

65 brake control unit

66 external sensor

67 tire pressure sensor

68 tire temperature sensor

FA (outer) free end of the outer wall part

FI (inner) free end of the inner wall part

LA longitudinal axis

LR longitudinal direction (parallel to the longitudinal axis)

lx, ly, lz local movement axes/axes of rotation/magnetic field measurement directions

QR transverse direction (perpendicular to the longitudinal axis)

RS uniform radius of the storage elements

UR circumferential direction

VR displacement direction

x, y, z vehicle axes

What is claimed is:

1. An electromechanical system is configured to be fixedly arranged in a central cavity of a wheel hub of a vehicle, the electromechanical system comprising:
a generator for generating electric current;
an electric motor for actuating an actuator;
the actuator; and
a storage system for storing electrical energy,
wherein the actuator is linearly movable along a longitudinal axis of the electromechanical system;
wherein a coupling device couples the motor to a radially inner part of the actuator;
wherein the storage system comprises a plurality of storage elements which are radially arranged around the outside of the longitudinal axis and the motor and at least some of which are spaced apart from one another in a circumferential direction, and
wherein a radially outer part of the actuator is formed radially beyond the storage elements;
wherein connecting elements of the actuator rigidly connect the radially inner part and the radially outer part to one another and reach through between the storage elements.

2. The electromechanical system according to claim 1, wherein the coupling device comprises a spindle which is mounted to rotate about the longitudinal axis and which is configured to be driven by the motor, wherein the spindle has an external thread, wherein the actuator has on its radially inner part an internal thread which is screwed onto the external thread of the spindle, and wherein the actuator is mounted where it cannot rotate with respect to the longitudinal axis.

3. The electromechanical system according to claim 1, wherein a rim cover for a vehicle wheel mounted on the wheel hub is coupled to the radially outer part of the actuator.

4. The electromechanical system according to claim 1, wherein the electromechanical system has a front end, wherein the electromechanical system can be inserted into the cavity of the wheel hub with the front end ahead, and has a rear end that is opposite said front end along the longitudinal axis, and in that a sequence of components of the electromechanical system is provided along the longitudinal axis from the front end to the rear end as follows: generator, coupling device, motor.

5. The electromechanical system according to claim 4, wherein the electromechanical system also comprises an intermediate board and a motherboard, and wherein the sequence of components of the electromechanical system along the longitudinal axis from the front end to the rear end is as follows: generator, intermediate board, coupling device, motor, motherboard.

6. The electromechanical system according to claim 1, wherein the electromechanical system comprises a sensor system, wherein the sensor system is configured to measure linear movements of the electromechanical system with respect to at least a first local movement axis and a second local movement axis, which are linearly independent, and also angular movements of the electromechanical system with respect to at least a first local axis of rotation and a second local axis of rotation, which are linearly independent of one another.

7. The electromechanical system according to claim 6, wherein the sensor system is further configured to measure a magnetic field strength at a measuring location in the electromechanical system with respect to at least a first local magnetic field measurement direction and a second local magnetic field measurement direction, which are linearly independent.

8. The electromechanical system according to claim 6, wherein a local movement axis and a local axis of rotation are selected as the longitudinal axis of the electromechanical system, which also corresponds to an axis of rotation of the wheel hub when the electromechanical system is assembled.

9. The electromechanical system according to claim 1, wherein the generator comprises a stator that is fixed in the electromechanical system and a rotor that can rotate relative to the stator, wherein the rotor is configured to have an imbalance element.

10. The electromechanical system according to claim 9, wherein the rotor is rotatably mounted within the stator, wherein one or more permanent magnets are formed on the rotor, and wherein one or more electromagnetic coils are formed on the stator.

11. The electromechanical system according to claim 1, wherein the electromechanical system comprises a plurality of spring contact pins configured for establishing electrical connections.

12. The electromechanical system according to claim 1, wherein the electromechanical system has a first communication device configured for wireless communication with an electronic system of the vehicle.

13. The electromechanical system according to claim 1, wherein the electromechanical system has a second communication device configured for wireless communication with one or more external sensors, and wherein the second communication device is also configured for wirelessly transmitting energy to the one or more external sensors in the form of passive external sensors.

14. The electromechanical system according to claim 1, wherein the electromechanical system has an evaluation device configured for evaluating measured data from sensors of the electromechanical system and/or from external sensors.

15. The electromechanical system according to claim 1, wherein the electromechanical system has at least one sensor for measuring a physical variable.

16. The electromechanical system according to claim 1, wherein the electromechanical system comprises at least one lighting device which is supplied with electrical energy by means of the generator and/or the storage system, wherein the at least one lighting device has one or more of the following functionalities:
direction indicator, warning light, emergency lighting, position lighting, decorative lighting.

17. The electromechanical system according to claim 1, wherein the electromechanical system has at least one magnetically actuated switch with which the electromechanical system can be activated and deactivated either in full and/or in part from outside a housing of the electromechanical system.

18. The electromechanical system according to claim 1, wherein the electromechanical system has an energy control device configured for controlling the consumption of electrical energy, which can be used to activate and deactivate components and/or functions of components of the electromechanical system.

19. The electromechanical system according to claim 1, wherein the electromechanical system has a housing which has a longitudinal wall extending at least substantially along the longitudinal axis, and in which at least one passage point for the actuator is provided, wherein an outer wall part and an inner wall part are provided in the region of each passage point in the longitudinal wall, which extend in parallel with the longitudinal axis, but are spaced apart from one another in the transverse direction perpendicularly to the longitudinal axis, are at least partially offset from one another along the longitudinal axis so that an inner free end of the inner wall part and an outer free end of the outer wall part are opposite one another in the region of the passage point, and wherein, at each passage point, the actuator has a central portion which extends along the longitudinal axis and is arranged in the transverse direction between the inner wall part and the outer wall part, an inner collar which is formed at an end of the central portion remote from the inner free end and extends inward in the transverse direction beyond the inner free end, and an outer collar which is formed at an end of the central portion remote from the outer free end and extends outward in the transverse direction beyond the outer free end.

20. A use of at least two electromechanical systems according to claim 1, wherein the at least two electromechanical systems are fixedly arranged in the central cavities of wheel hubs of at least two vehicle wheels, being steered vehicle wheels, of a vehicle,
wherein each electromechanical system records measured data relating to the current state of the vehicle wheel by means of one or more sensors of the electromechanical system, wherein a first communication device of the electromechanical system is used to wirelessly transmit these measured data or information obtained from these measured data to an electronic system of the vehicle, and wherein the electronic system of the vehicle takes the transmitted measured data or information into account when adjusting vehicle properties and/or when controlling the vehicle.
